(19) United States
(12) Patent Application Publication
(10) Pub. No.: US 2010/0208566 A1
(43) Pub. Date: Aug. 19, 2010

(54) METHOD AND APPARATUS FOR PERFORMING LAYER CHANGES FOR AN OPTICAL DISK DRIVE

(75) Inventors: Keng-Hao Chang, Taipei County (TW); Jyh-Haur Chen, Kaohsiung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/372,827

(22) Filed: Feb. 18, 2009

(51) Int. Cl. G11B 7/00

(52) U.S. Cl. 369/112.01; G9B/7

(57) ABSTRACT

The invention provides a method for performing layer changes for an optical disk drive. In one embodiment, the optical disk drive intends to move a focus of a laserbeam emitted by a pickup head from a present layer onto a target layer of an optical disk. First, an amplitude ratio between a first amplitude of a first S-curve of a previous focusing error signal and a second amplitude of a second S-curve of the previous focusing error signal is determined. The object lens is then moved towards a target position for focusing of the laserbeam on the target layer. A focusing error signal is then generated. The focusing error signal is then amplified or attenuated according to the amplitude ratio to obtain an amplified or attenuated focusing error signal. Whether the object lens has reached the target position is then determined according to the amplified or attenuated focusing error signal.

### BACKGROUND OF THE INVENTION

1. Field of the Invention

The invention relates to optical disk drives, and more particularly to layer changes of optical disk drives.

2. Description of the Related Art

Optical disks of specific categories such as Blu-ray disks (BD) have multiple data layers for storing greater amounts of data in a single disk. To access data of a data layer of an optical disk, a pickup head of an optical disk drive must project a focus of a laserbeam on the data layer and then detect reflection of the laserbeam from the data layer to obtain a reflection signal. The optical disk drive then decodes the reflection signal to obtain data. When an optical disk has completed data access of a present layer of an optical disk and intends to access data of a target layer other than the present layer, the optical disk drive must perform a layer change procedure to move the focus of laserbeam of the object lens from the present layer to the target layer.

Because each layer has a corresponding distance between a corrector lens and an objective lens, the distance is adjusted for correcting spherical aberration whenever a layer change procedure is performed, referred to as a spherical aberration correction process. When an optical disk such as a digital versatile disk (DVD) having data layers with a greater distance there between is accessed, a layer change procedure can be performed without executing a spherical aberration correction process.

FIG. 1A shows a laserbeam projected to a DVD disk during a layer change procedure performed without spherical aberration correction. The DVD disk has a surface layer S and two data layers L₁ and L₀. The distance between the data layers L₁ and L₀ is long, and the wave length of laserbeam used in the DVD drive is also long enough to enable the focus being not affected by spherical aberration. After the layer change procedure moves a focus of the laserbeam from the previous data layer L₁ to the target data layer L₀, although no spherical aberration correction process is performed, the laserbeam can be still acceptably focused on the target data layer L₀ due to the long data layer distance.

When an optical disk such as a blu-ray disk (BD) having data layers with a shorter distance there between is accessed, a spherical aberration correction process must be performed in accompany with a layer change procedure. FIG. 1B shows a schematic diagram of a laserbeam projected to a BD disk without spherical aberration correction. The BD disk has a surface layer S and two data layers L₁ and L₀. The distance between the data layers L₁ and L₀ is short, and the wave length of laserbeam used in the BD drive is also short to make the focus being more affected by spherical aberration. After the layer change procedure moves a focus of the laserbeam from the previous data layer L₁ to the target data layer L₀, the laserbeam can not easily be focused on the target data layer L₀ due to the short data layer distance Spherical aberration correction must therefore be made in accompany with a layer change, and data can therefore be correctly decoded according to a regular reflection signal derived from the target layer.

In addition, a distance between the object lens of the pickup head and the optical disk must be adjusted to move the focus of the laserbeam emitted by the pickup head from the present layer to the target layer. To determine whether the object lens reaches a target position for the pickup head to focus the laserbeam on the target layer, a focusing error signal is generated while the object lens is being moved. When the optical disk drive detects an S-curve induced by the target layer in the focusing error signal, the focus of the laserbeam is projected on the target layer, and the optical disk drive halts the motion of the object lens.

Referring to FIG. 2, a focusing error signal generated while an object lens is being moved towards a disk is shown. The S-curve 102 with the smallest amplitude is induced by a surface of the disk. Two S-curves 104 and 106 are respectively induced by a present layer and a target layer. Because the spherical aberration of the present layer has been corrected, the S-curve 104 corresponding to the present layer will have better quality, such as having an amplitude greater than that of the S-curve 106 corresponding to the target layer. Because the small amplitude of the S-curve 106 may cause the optical disk drive to miss identification of the target layer, the spherical aberration of the target layer is often corrected by movement or operation of a spherical aberration corrector (such as lens or a LCD device) before the object lens is moved in a conventional layer change procedure.

When the spherical aberration is not corrected, the amplitude of the S-curve 106 induced by the target layer is small. When the amplitude of the S-curve 106 is less than a threshold, the S-curve 106 is not identified, and the optical disk drive cannot find the target position of the object lens of pickup head for focusing of the laserbeam on the target layer. Because the distance between the corrector lens and the objective lens of the pickup head is adjusted with a stepping motor with a slow speed, the spherical aberration correction requires a great amount of time, causing delays in the layer change procedure and degrading performance of the optical disk drive. A method for performing layer changes is therefore provided to improve the performance of an optical disk drive.

### BRIEF SUMMARY OF THE INVENTION

The invention provides a method for performing layer changes for an optical disk drive. In one embodiment, the optical disk drive intends to move a focus of a laserbeam from a present layer of an optical disk onto a target layer of the optical disk. First, an amplitude ratio between a first amplitude of a first S-curve of a previous focusing error signal and a second amplitude of a second S-curve of the previous focusing error signal is determined, wherein the first S-curve and the second S-curve respectively correspond to the present layer and the target layer. The object lens of the pickup head is then moved towards a target position for focusing of the laserbeam on the target layer. A focusing error signal is then generated while the object lens is moving. The focusing error signal is then amplified or attenuated according to the amplitude ratio to obtain an amplified or attenuated focusing error signal. Whether the object lens has reached the target position is then determined according to the amplified or attenuated focusing error signal. Finally, motion of the object lens of the pickup head is halted when the object lens is determined to have reached the target position.

The invention provides an optical disk driving module performing layer changes. The optical disk drive intends to move a focus of a laserbeam from a present layer of an optical disk onto a target layer of the optical disk. In one embodiment, the optical disk drive comprises a focusing error generator and a digital signal processing system. The focusing error generator generates a focusing error signal according to a reflection signal generated by a pickup head while an object lens is moving. The digital signal processing system determines an amplitude ratio between a first amplitude of a first S-curve of a previous focusing error signal and a second amplitude of a second S-curve of the previous focusing error signal, amplifies or attenuates the focusing error signal according to the amplitude ratio to obtain an amplified or attenuated focusing error signal, determines whether the object lens has reached the target position according to the amplified or attenuated focusing error signal, and halts moving of the object lens of pickup head when the object lens is determined to have reached the target position, wherein the first S-curve and the second S-curve respectively correspond to the present layer and the target layer.

The invention also provides a method for controlling layer changes for an optical disk drive. In one embodiment, the optical disk drive intends to move a focus of a laserbeam emitted by a pickup head from a present layer of an optical disk onto a target layer of the optical disk. First, the object lens of the pickup head is moved towards a target position for focusing the laserbeam on the target layer. A focusing error signal is then generated while the object lens is moving. Reflection signals generated by the pickup head are then summed to obtain a summation signal. Amplitude of the summation signal is then compared with a threshold to determine whether the laserbeam is projected on a blank area or a data area of the target layer. The focusing error signal is then amplified or attenuated based on information stored in the lead-in area of the disc when the laserbeam is determined to be projected on the blank area. Whether the object lens has reached the target position is then determined according to the amplified or attenuated focusing error signal. Moving of the object lens is then halted when the object lens is determined to have reached the target position.

The invention also provides an optical disk driving module. The optical disk driving module intends to move a focus of a laserbeam emitted by a pickup head from a present layer of an optical disk onto a target layer of the optical disk. In one embodiment, the optical disk drive comprises a focusing error generator, a summing circuit, and a digital signal processing system. The focusing error generator generates a focusing error signal according to a reflection signal of the laserbeam while an object lens is moving. The summing circuit generates a summation signal reflecting strength of the reflection signal. The digital signal processing system compares an amplitude of the summation signal with a threshold to determine whether the laserbeam is projected on a blank area or a data area of the target layer, amplifies or attenuates the focusing error signal when the laserbeam is determined to be projected on the blank area, determines whether the object lens of the pickup head has indeed reached the target position according to the amplified or attenuated focusing error signal, and halts moving of the object lens when the object lens is determined to have reached the target position.

The invention also provides an optical disk driving module. In one embodiment, the optical disk driving module comprises a spherical aberration correction driver, a focus error generator, and a micro processor. The spherical aberration correction driver drives the spherical aberration corrector according to a spherical aberration index when a layer change procedure is performed. The focus error generator derives a focusing error signal from a reflection signal according to a gain and/or an offset, wherein the reflection signal is derived from an optical disk. The micro processor generates an adjusting signal to direct the focus error generator to adjust the gain and the offset according to the spherical aberration index, thus keeping the focus error signal at an appropriate level while spherical aberration is corrected.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic diagram of a laserbeam focused on a target layer with spherical aberration correction;

FIG. 1B is a schematic diagram of a laserbeam focused on a target layer without spherical aberration correction;

FIG. 2 shows a focusing error signal generated while a pickup head is being moved towards a disk;

FIG. 3 is a block diagram of an optical disk drive performing a layer change according to the invention;

FIG. 4A is a flowchart of a method for determining a gain for amplifying or attenuating a focusing error signal according to the invention;

FIG. 4B shows a focusing error signal generated in step 404 of FIG. 4A;

FIG. 5 shows a flowchart of a method for performing a layer change procedure according to the invention;

FIG. 6 is a block diagram of an optical disk drive performing a layer change procedure according to the invention;

FIG. 7 is a flowchart of a method for performing a layer change according to the invention;

FIG. 8 is a schematic diagram of signals generated by the optical disk drive 600 of FIG. 6 while a layer change is performed;

FIG. 9 is a block diagram of an optical disk drive adjusting a gain and an offset of a focus error signal during spherical aberration correction according to the invention;

FIG. 10A is a schematic diagram of an embodiment of gain adjustment of a focus error signal according to a spherical aberration position during a layer change;

FIG. 10B is a schematic diagram of another embodiment of gain adjustment of a focus error signal according to a spherical aberration position during a layer change;

FIG. 11A is a schematic diagram of an embodiment of offset adjustment of a focus error signal according to a spherical aberration position during a layer change; and

FIG. 11B is a schematic diagram of another embodiment of offset adjustment of a focus error signal according to a spherical aberration position during a layer change.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. Moreover, the label numbers or arrows of the flowchart are used for description conveniently, not used to limit the sequence or order of steps of the methods.

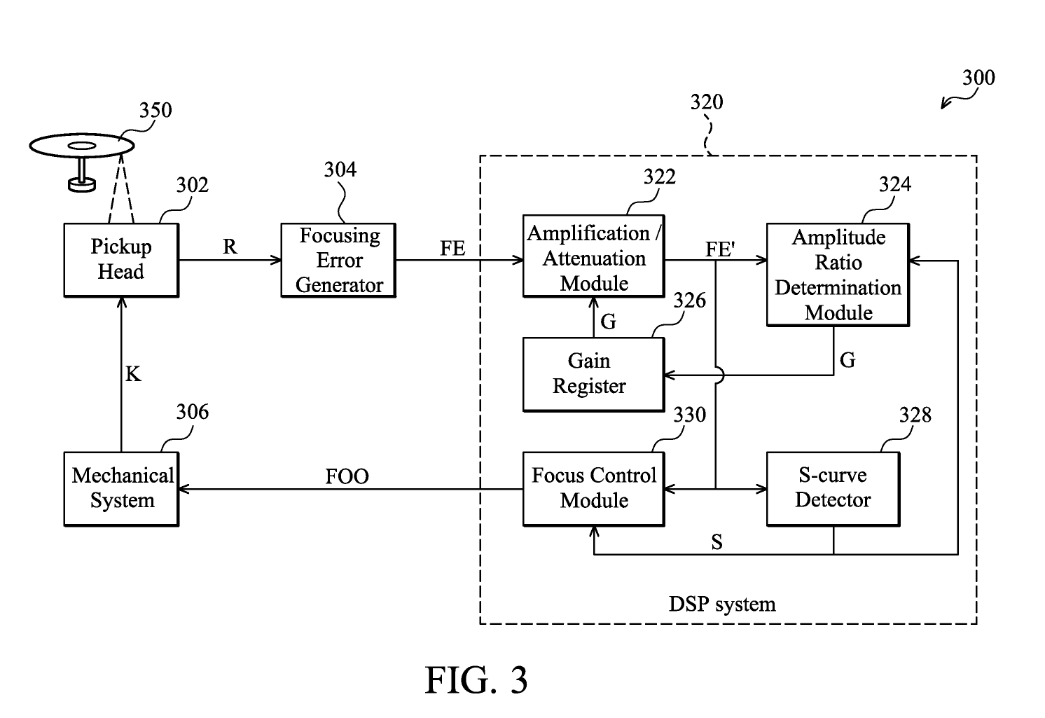

Referring to FIG. 3, a block diagram of an optical disk drive 300 performing layer changes according to the invention is shown. An optical disk 350 is inserted in the optical disk drive 300 to be accessed. The optical disk 350 has multiple data layers for storing data. In one embodiment, the optical disk 350 is a Blu-ray disk (BD). The optical disk drive 300 comprises a pickup head 302, a focusing error generator 304, a mechanical system 306, and a digital signal processing (DSP) system 320. The optical disk drive 300 performs a layer change procedure to move a focus of a laserbeam emitted by the pickup head 302 from a present layer of the optical disk 350 onto a target layer of the optical disk 350. The digital signal processing system 320 first generates a focus servo output signal FOO to direct the mechanical system 306 to move the pickup head 302. The pickup head 302 emits a laserbeam and detects reflection of the laserbeam from the disk to obtain a reflection signal R. The focusing error generator 304 then generates a focusing error signal FE according to the reflection signal R. The focusing error signal FE is then delivered to the digital signal processing system 320.

The digital signal processing system 320 then detects whether an S-curve corresponding to the target layer is present in the focusing error signal FE to identify the target position for the pickup head, and the laserbeam focus on the target layer thereby. Because a distance between a collimator lens and an objective lens has not been adjusted to correct spherical aberration, the S-curve corresponding to the target layer has smaller amplitude and may be ignored by the digital signal processing system 320. The digital signal processing system 320 therefore determines a gain in advance and amplifies the focusing error signal FE according to the gain to obtain an amplified focusing error signal. Thus, the S-curve corresponding to the target layer is not easily missed. When the S-curve is detected, the focus of the laserbeam is projected on the target layer, and the digital signal processing system 320 generates the focus servo output signal FOO to halt moving the pickup head 302. A layer change procedure without movement or operation of the spherical aberration corrector is therefore completed.

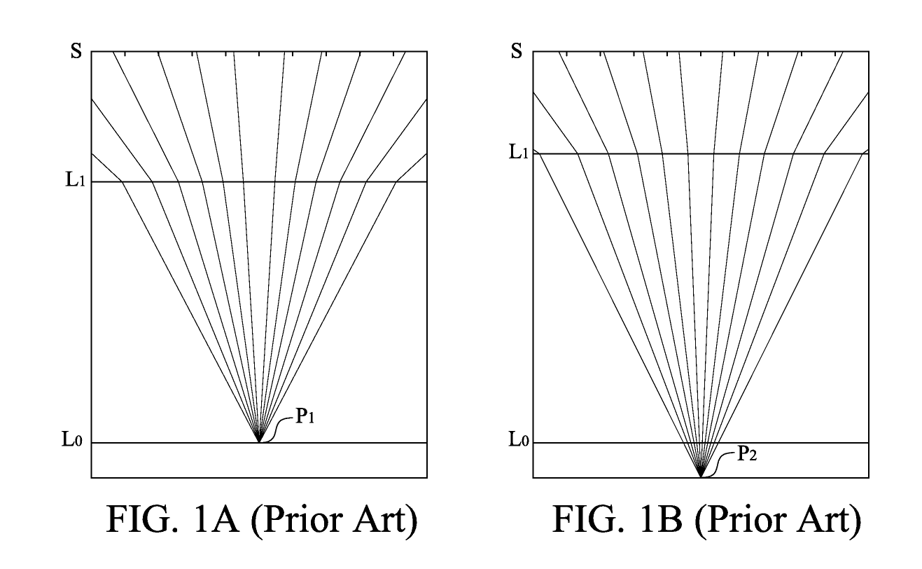

It should be noted that the change of amplitude from the present layer to the target layer is depended on types of the disc. For example, the amplitudes get smaller from the S-curve 104 of present layer to the S-curve 106 of target layer in FIG. 1C. On the other hand, the amplitudes may get bigger from the S-curve of present layer to the S-curve of target layer on other kinds of disc. The optical disk drive 300 can previously identify that how the amplitudes of S-curve properly change by reading information from a lead-in area of the disc to know whether the blank region is a high reflective region (large amplitude) or a low reflective region (small amplitude,). For example, the Blu-ray disc has both kinds of blank region with low or high reflective region. The following description takes that the amplitudes get smaller from the S-curve 452 of the present layer to the S-curve 454 of target layer, and the blank region is a high reflective region as an example.

Moreover, the focusing error generator 304 and the digital signal processing system 320 can be considered as an optical disk driving module, which can be implemented in a chip.

In one embodiment, the digital signal processing system 320 comprises an amplification/attenuation module 322, an amplitude ratio determination module 324, a gain register 326, an S-curve detector 328, and a focus control module 330. To determine the gain value for amplifying or attenuating the focusing error signal FE, a gain determination process is performed when the disk 350 is inserted into the optical disk drive 300.

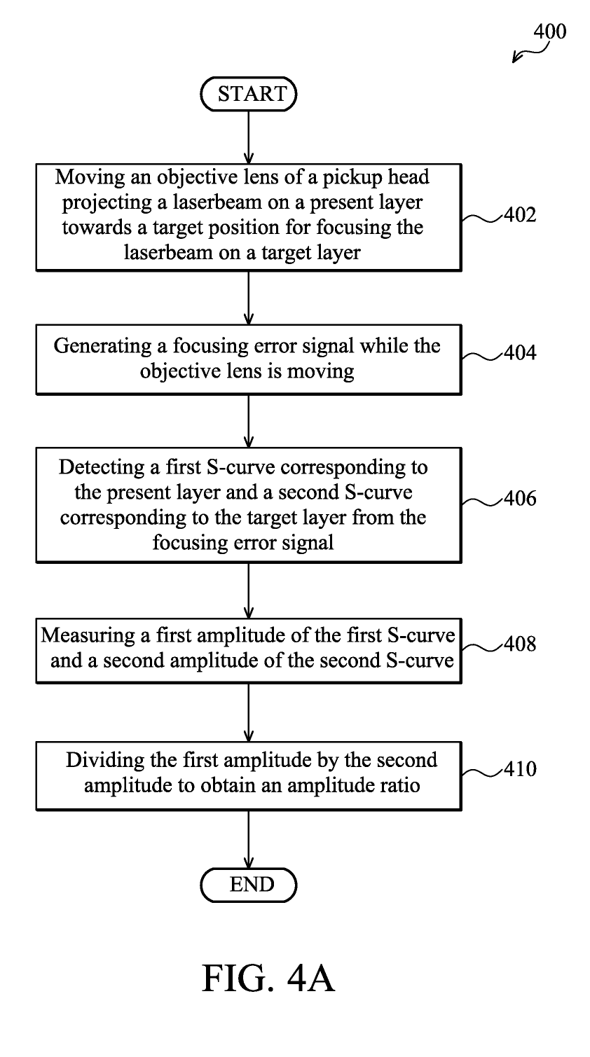

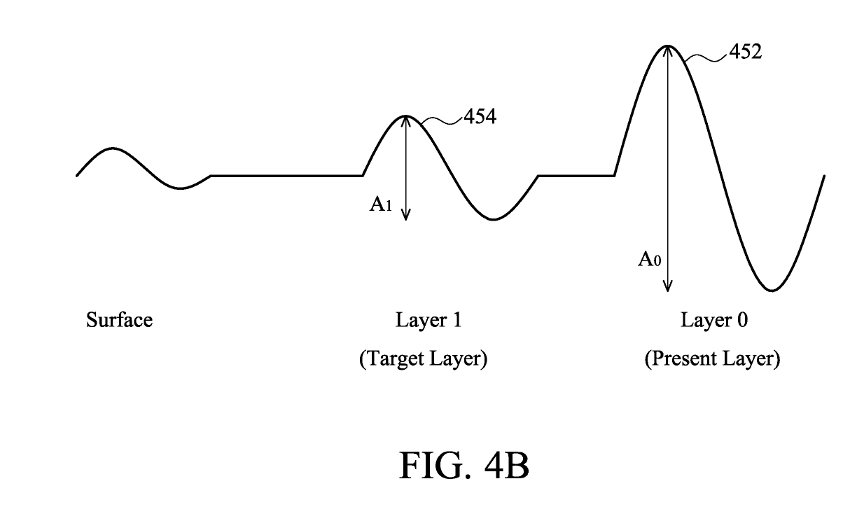

Referring to FIG. 4A, a flowchart of a method 400 for determining a gain for amplifying or attenuating the focusing error signal according to the invention is shown. Since optical disk drive usually reads the lead-in area first, thus the information about whether the blank region is high reflective or low reflective will be identified. Then, the focus control module 330 generates the focus servo output signal to direct the mechanical system 306 to move an objective lens of the pickup head 302 to project a laserbeam on a present layer towards a target position for focusing of the laserbeam on a target layer (step 402). While the pickup head 302 is moving, the focusing error generator 304 generates a focusing error signal FE according to the reflection signal R generated by the pickup head 302 (step 404).

Referring to FIG. 4B, a focusing error signal generated in step 404 of FIG. 4A is shown. Two S-curves 454 and 452 are present in the focusing error signal. Because spherical aberration has not been corrected, an S-curve 454 corresponding to the target layer has a smaller amplitude A₁ and an S-curve 452 corresponding to the present layer has a greater amplitude A₀. The S-curve detector 328 first detects the S-curve 452 corresponding to the present layer and the S-curve 454 corresponding to the target layer from the focusing error signal (step 406). The amplitude ratio determination module 324 then measures an amplitude A₀ of the S-curve 452 and an amplitude A₁ of the S-curve 454 (step 408), and then divides the amplitude A₀ by the amplitude A₁ to obtain an amplitude ratio G (step 410), which is taken as the gain for amplifying or attenuating the focusing error signal afterward.

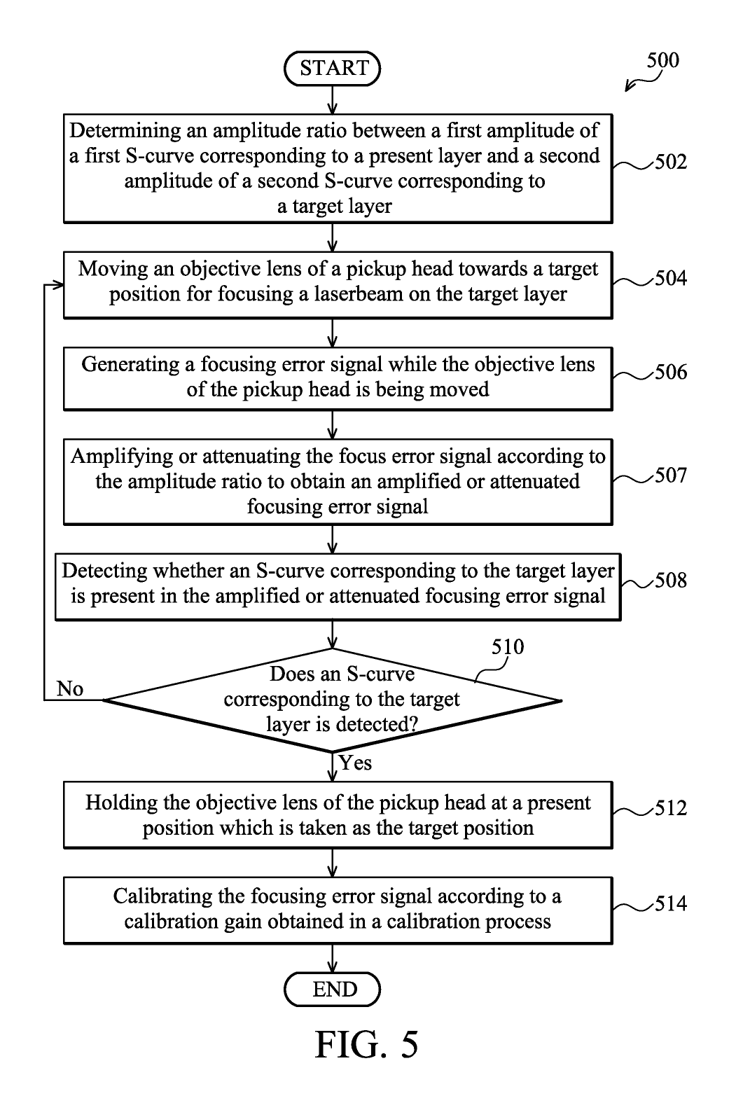

Referring to FIG. 5, a flowchart of a method 500 for performing a layer change procedure according to the invention is shown. After the amplitude ratio determination module 324 determines the amplitude ratio G according to the method 400, the amplitude ratio G is stored in the gain register 326 (step 502). When the optical disk drive 300 starts to perform the layer change procedure to move a focus of a laserbeam emitted by the pickup head 302 from a present layer of the optical disk 350 onto a target layer of the optical disk 350, the mechanical system 306 first moves an objective lens of the pickup head 302 towards a target position for focusing of the laserbeam on the target layer (step 504). The focusing error generator 304 then generates a focusing error signal FE while the objective lens of the pickup head 302 is moving (step 506). The amplification/attenuation module 322 then amplifies or attenuates the focusing error signal FE according to the amplitude ratio to obtain an amplified or attenuated focusing error signal FE′ (step 507).

The S-curve detector 328 then detects whether an S-curve S corresponding to the target layer is present in the amplified or attenuated focusing error signal FE′ (step 508). Because the focusing error signal FE′ has been amplified or attenuated according to the amplitude ratio, the S-curve corresponding to the target layer has a greater or less amplitude and won't be neglected by the S-curve detector 328. When S-curve detector 328 detects the S-curve S corresponding to the target layer (step 510), the focus of the laserbeam is projected on the target layer, and the present position of the pickup head 302 is the target position. The focus control module 330 generates the focus servo output signal FOO to halt moving the objective lens of the pickup head 302, and the objective lens of the pickup head 302 is held at the present position (step 512). A layer change procedure is therefore completed. Finally, after the layer change procedure is completed, a calibrated gain of the focusing error signal determined during a calibration process in advance is restored into the gain register 326, and the amplification/attenuation module 322 amplifies or attenuates the focusing error signal FE according to the calibrated gain (step 514).

Some kinds of optical disks such as Blu-ray disks (BD) let user record data on any sections of the data layers thereof. Thus, when a layer change procedure is performed, a laserbeam emitted by a pickup head may be projected on a data area or a blank area of the optical disk. When the laserbeam is projected on a blank area where no data is written, the reflection signal of the laserbeam has greater amplitude. When the laserbeam is projected on a data area where data is written, the reflection signal of the laserbeam has smaller amplitude. Because the focusing error signal is derived from the reflection signal, the amplitude of the focusing error signal increases with that of the reflection signal. When the layer change is performed, a conventional optical disk drive cannot predict whether the laserbeam is projected on a blank area or a data area of the optical disk by weak amplitude of the focusing error signal, and the unpredictable amplitude of the tracking error signal reduces correctness of S-curve detection, and degrades the performance of the conventional optical disk drive.

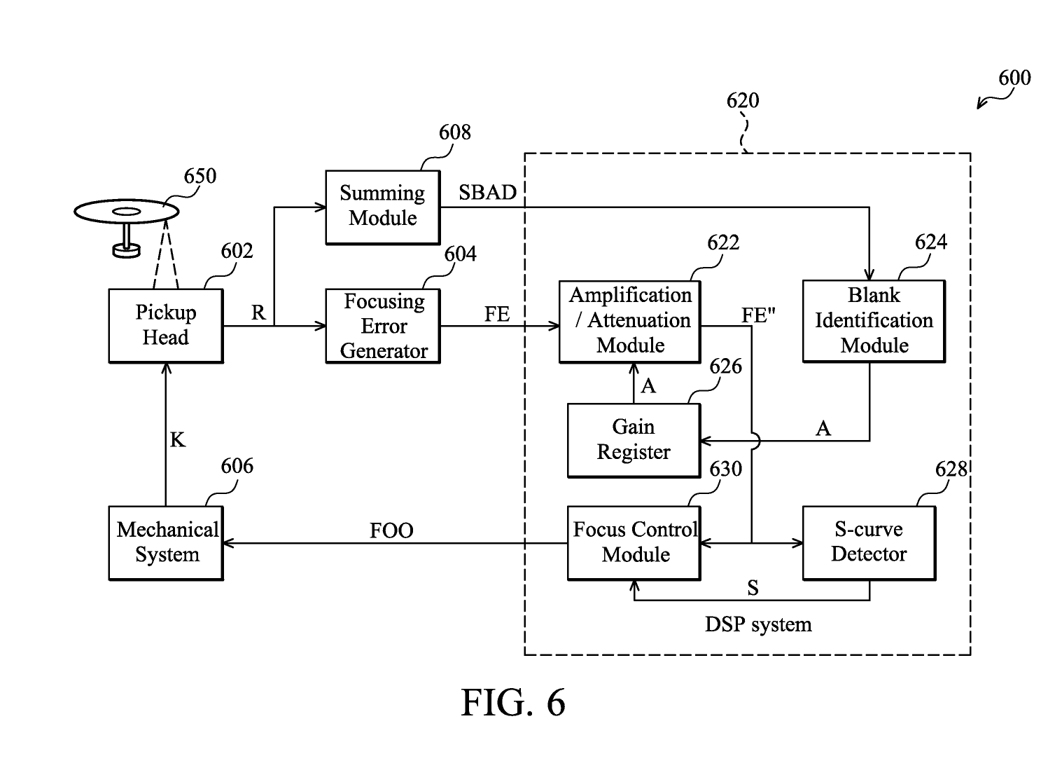

The invention therefore provides an optical disk drive capable of predicting whether a laserbeam is projected on a blank area or a data area of an optical disk when a layer change procedure is performed. Referring to FIG. 6, a block diagram of an optical disk drive 600 performing a layer change procedure according to the invention is shown. Compared with the optical disk drive 300 of FIG. 3, a summing module 608 and a blank identification module 624 are added to the optical disk drive 600. A pickup head 602 detects reflection of a laserbeam from the disk 650 with a plurality of photodetectors, and each photodetector generates a reflection signal. The summing module 608 sums the reflection signals generated by the photodetectors to obtain a summation signal SBAD reflecting strength of the reflection of the laserbeam. Thus, the blank identification module 624 then determines whether the laserbeam is projected on a data area or a blank area according to the summation signal SBAD.

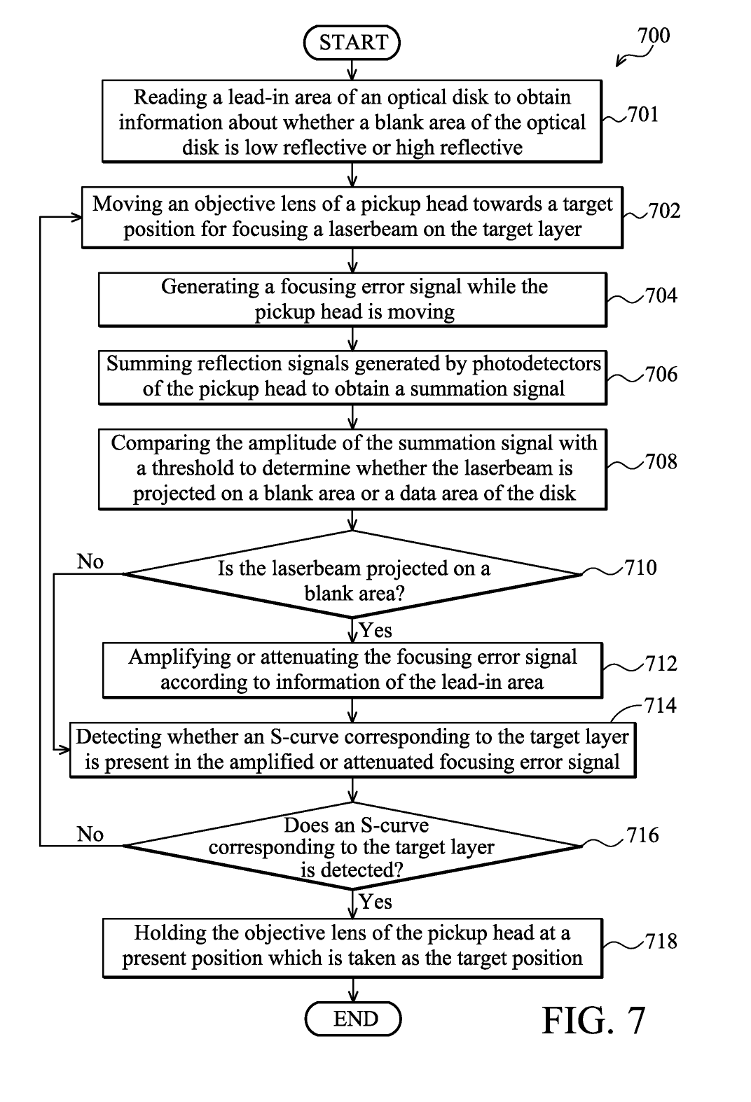

Referring to FIG. 7, a flowchart of a method 700 for performing a layer change according to the invention is shown. The optical disk drive 600 first reads a lead-in area of the optical disk 650 to obtain information about whether a blank region of the optical disk 650 is high reflective or low reflective (step 701). Then, the mechanical system 606 moves an objective lens of the pickup head 602 towards a target position for focusing of a laserbeam emitted by the pickup head 602 on a target layer (step 702). The focusing error generator 604 then generates a focusing error signal FE while the pickup head 602 is moving (step 704). In addition, the summing module 608 sums reflection signals generated by photo detectors of the pickup head 602 to obtain a summation signal SBAD (step 706). The blank identification module 624 then compares the amplitude of the summation signal SBAD with a threshold Th (not shown) to determine whether the laserbeam is projected on a blank area or a data area of the disk (step 708).

Moreover, the focusing error generator 604, summing module 608, and the digital signal processing system 620 can be considered as an optical disk driving module, which can be implemented in a chip.

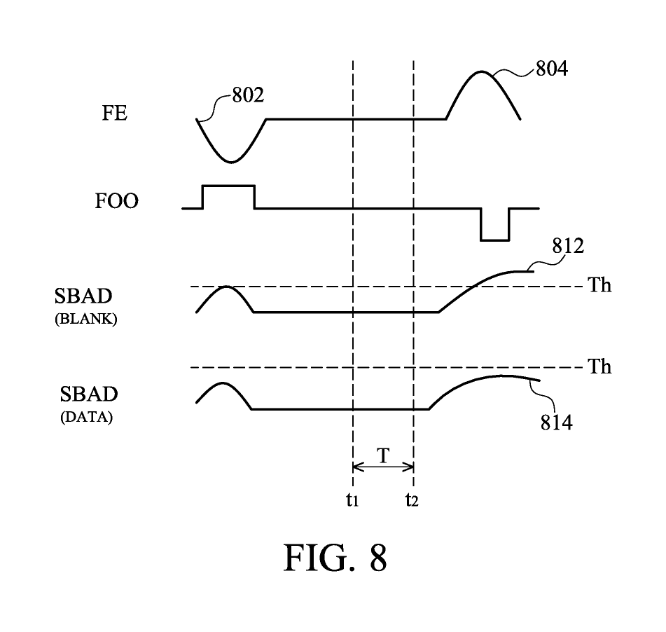

FIG. 8 shows a schematic diagram of signals generated by the optical disk drive 600 of FIG. 6 while a layer change is performed. The signals of FIG. 8 includes the focusing error signal FE, the focus servo output signal FOO, a summation signal SBAD_{(BLANK)} corresponding to a blank area, and a summation signal SBAD_{(DATA)} corresponding to a data area. The S-curve 802 corresponds to a present layer, and the S-curve 804 corresponds to a target layer. After a protection period T has passed, the blank identification module 624 starts to sample the summation signal SBAD. When the amplitude 812 of the summation signal SBAD exceeds the threshold Th, the blank identification module 624 determines that the laserbeam is projected on a blank area. When the amplitude 814 of the summation signal SBAD does not exceed the threshold Th, the blank identification module 624 determines that the laserbeam is projected on a data area.

When the blank identification module 624 determines that the laserbeam is projected on a blank area (step 710), the blank identification module 624 stores an amplitude ratio A into the gain register 626. If information of the lead-in area indicate that the blank region is a high reflective region in the step 701, the amplification/attenuation module 622 then attenuates the focusing error signal FE according to the amplitude ratio A and information of the lead-in area to obtain an attenuated focusing error signal FE″ (step 712). Otherwise, if information of the lead-in area indicates that the blank region is a low reflective region, the amplification/attenuation module 622 then amplifies the focusing error signal FE and information of the lead-in area according to the amplitude ratio A to obtain an amplified focusing error signal FE″ (step 712). After the focusing error signal is amplified or attenuated, the amplitude of the amplified/attenuated focusing error signal FE″ corresponding to the blank area is the same as the amplitude of the original focusing error signal FE corresponding to the data area. Thus, the amplitude of the amplified/attenuated focusing error signal FE″ will not change according to whether the laserbeam is projected on a data area or a blank area. The S-curve detector 628 then detects an S-curve S corresponding to the target layer in the amplified or attenuated focusing error signal FE″ (step 714). When the S-curve S corresponding to the target layer is detected (step 716), the focus control module 630 sends the focus servo output signal FOO to the mechanical system 606 to hold the objective lens of the pickup head 606 at the present position (step 718). The focus of laserbeam emitted by the pickup head 602 at the present position is projected on the target layer of the optical disk 650, and a layer change procedure is therefore completed.

In one embodiment, the invention provides a method for performing a layer change procedure. Because the spherical aberration correction is omitted, the time required by the layer change procedure is reduced, improving the performance of the optical disk drive. In another embodiment, the invention provides a method for identifying whether a laserbeam is projected on a data area or a blank area when a layer change procedure is performed. Because the amplitude of the focusing error signal is adjusted according to whether the laserbeam is projected on a data area or a blank area, the accuracy of S-curve detection is improved, improving the performance of the optical disk drive.

Thus, when a layer change procedure is performed to move a focus of a laserbeam from a present data layer to a target data layer; a spherical aberration (SA) index can be used to improve quality of received signals. The spherical aberration index can be such as a position of a spherical aberration corrector (constituted by lens), or a refractive index of an LCD device allocated along the path where laserbeam pass through. The embodiment described here takes adjusting spherical aberration by changing distance between the spherical aberration corrector and the objective lens as an example.

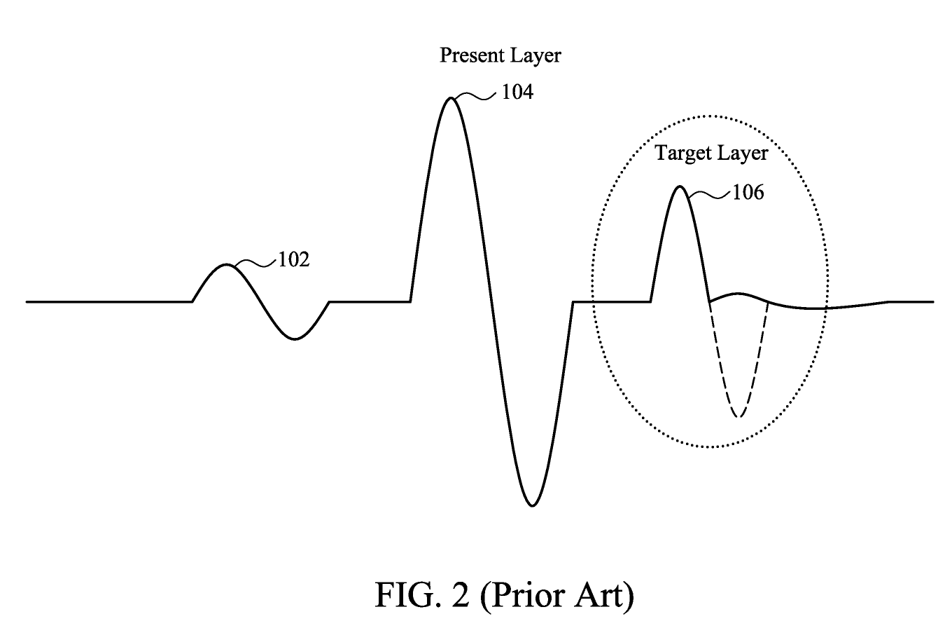

Thereafter, the optical disk drive detects an S-curve in the amplified or attenuated focus error signal to determine whether to hold motion of an object lens, thus completing the layer-change procedure. In a conventional layer change procedure such as the embodiment shown in FIG. 2, an optical disk drive is required to perform a spherical aberration correction process for adjusting a position of a spherical aberration corrector, wherein the position of the spherical aberration corrector is referred to as a spherical aberration position.

In a conventional layer change procedure, when the spherical aberration corrector position is adjusted, amplitude of a focus error signal is often changed due to spherical aberration. If a gain and/or an offset of the focus error signal are not carefully compensated, FE amplitude is too small, and a focus point of the object lens can not be determined, thus resulting in a focus drop. Moreover, compensating the gain and the offset of the focus error signal also improves the stability of focus servo control.

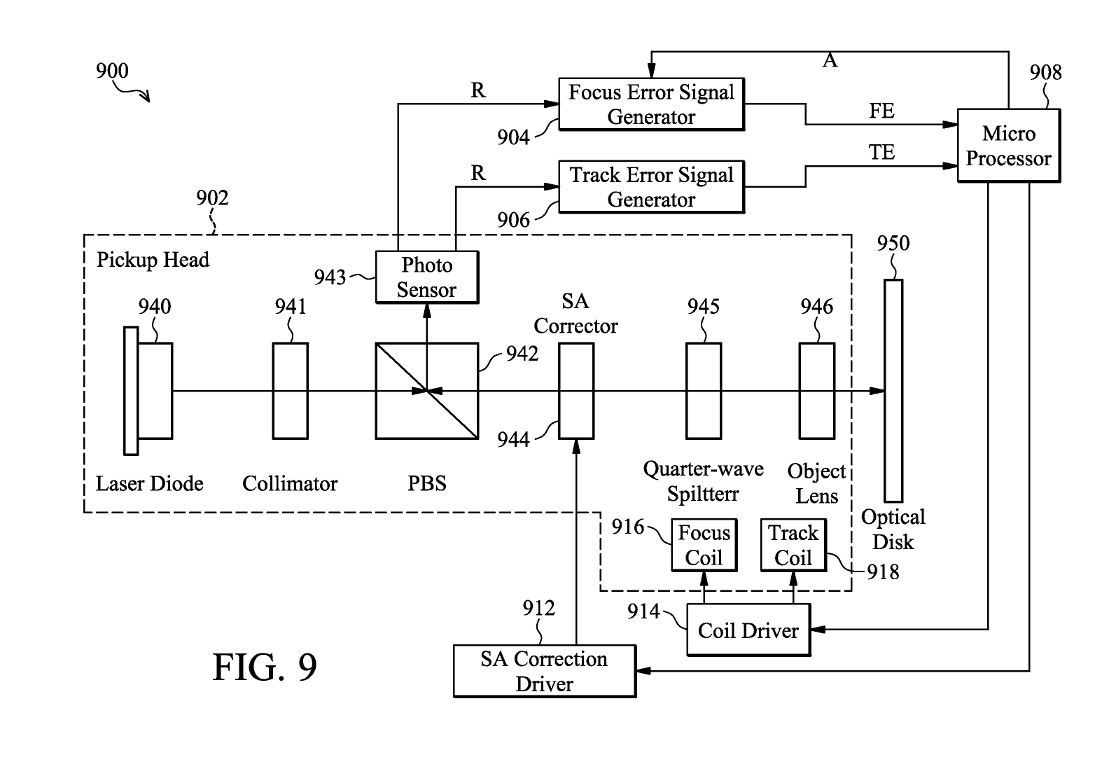

An optical disk drive adjusting a gain and/or an offset of a focus error signal during spherical aberration correction is therefore provided. Referring to FIG. 9, a block diagram of an optical disk drive 900 adjusting a gain and/or an offset of a focus error signal during spherical aberration correction according to the invention is shown. A pickup head 902 of the optical disk drive 900 projects a laserbeam on an optical disk 950. In one embodiment, the pickup head 902 comprises a laser diode 940, a collimator lens 941, a polarized beam splitter (PBS) 942, a photo sensor 943, a spherical aberration (SA) corrector 944, a quarter-wave splitter 945, and an objective lens 946. The laser diode 940 generates the laser beam projected on the optical disk 950. The photo sensor 943 detects the reflection of the laserbeam from the optical disk 950 to generate a reflection signal R. An SA correction driver 912 changes a position of the SA corrector 944 to correct spherical aberration according to instruction from a micro processor 908 which is cooperated with a digital signal processor (DSP) system (not shown).

The optical disk drive 900 comprises the pickup head 902, a focus error signal generator 904, a track error signal generator 906, the micro processor 908, the SA correction driver 912, a coil driver 914, a focus coil 916, a track coil 918, and an object lens 946. The tracking error signal generator 906 generates a tracking error signal TE according to the reflection signal R and sends the tracking error signal TE to the microprocessor 908. When a layer change procedure is performed, the micro processor 908 directs the SA correction driver 912 to adjust the position of the SA corrector 944. In the meanwhile, the micro processor 908 directs the focus coil 916 to move the object lens 946 towards or apart from the optical disk surface 950 via the coil driver 914. The focus error signal generator 904 derives a focus error signal FE from the reflection signal R according to a gain and an offset. When position of the spherical aberration corrector 944 is adjusted, the micro processor 908 generates an adjusting signal A for the focus error signal generator 904 to adjust the gain and the offset of the focus error signal FE according to the position of the SA corrector 944, thus avoiding distortion of the focus error signal due to change of the position of the SA corrector 944. In one embodiment, the gain and the offset are functions based on the position of the SA corrector 944, the functions defines values of the gain and the offset according to the position of the SA corrector 944. The micro processor 908 then detects an S-curve in the focus error signal FE to determine whether to direct the focus coil to stop moving the object lens 946 of the pickup head 902, thus focusing the object lens 946 at a target position for focusing the laserbeam on a target data layer of the optical disk 950.

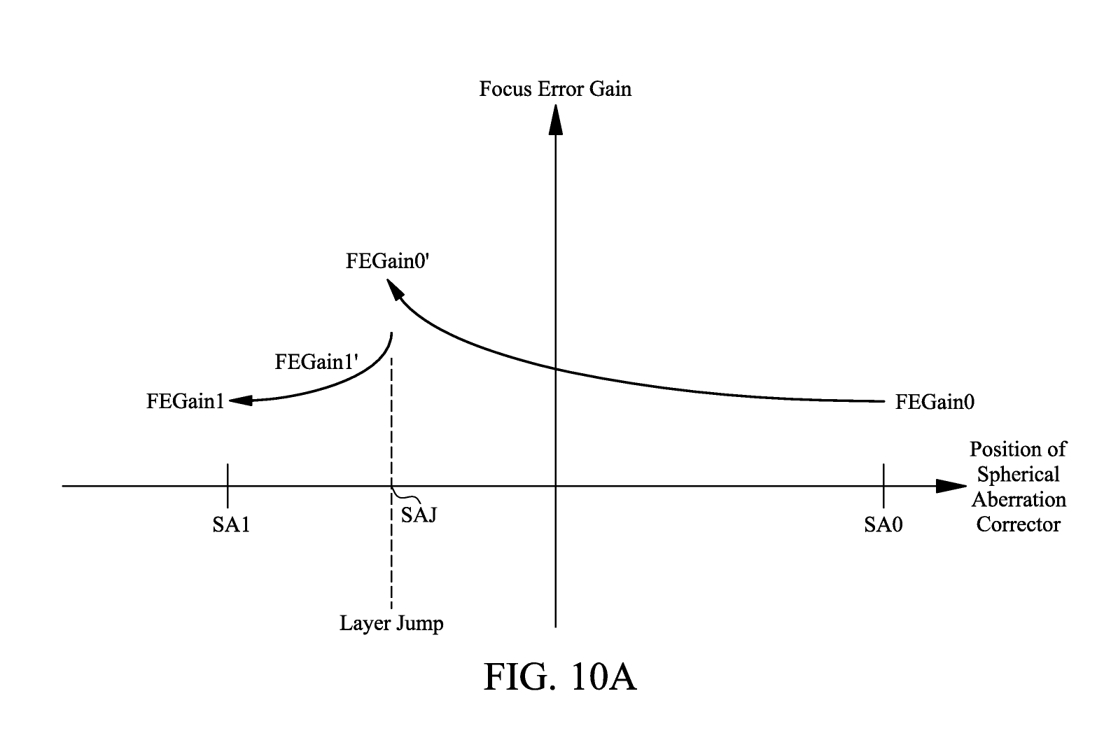

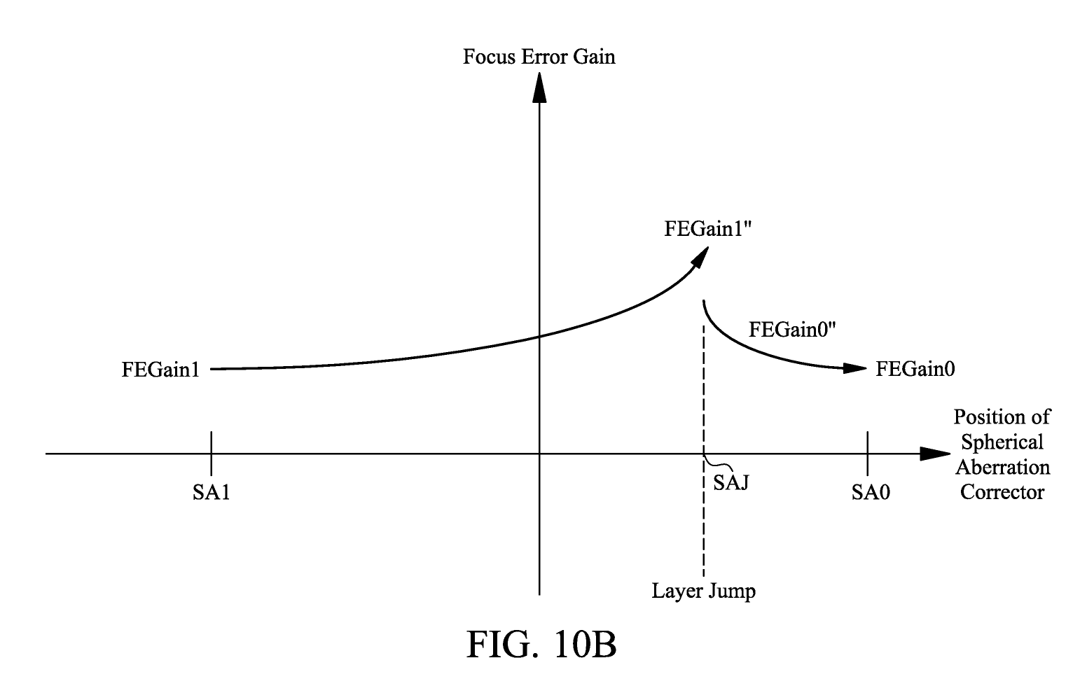

Referring to FIG. 10A, a schematic diagram of an embodiment of gain adjustment of a focus error signal according to a spherical aberration position during a layer change is shown. Before a layer change procedure is performed, a focus spot of a laserbeam emitted by the laser diode 940 is on a present data layer of the optical disk 950. A spherical aberration position of the spherical aberration corrector 944 is at SA0, and a gain for generating the focusing error signal FE is FEGain0. When the SA correction driver 912 moves the spherical aberration corrector 944 from the position SA0 towards a position SA1, the micro processor 908 sends an adjusting signal A to the focus error signal generator 904, thus gradually adjusting the gain of the focus error signal FE from the value FEGain0 to the value FEGain0′. It is noted that the gain of the focus error signal FE can be adjusted according to some specific functions in some embodiments, thus the adjustment of gain is controlled by the functions.

After the layer change occurs, the gain of the focus error signal FE is changed from FEGain0′ to FEGain1′. The spherical aberration correction driver 912 continues moving the spherical aberration corrector 944 towards the position SA1, and the micro processor 908 sends the adjusting signal A to the focus error signal generator 904 to gradually adjust the gain of the focus error signal FE from the value FEGain1′ to the value FEGain1. The amplitude of the focus error signal FE is therefore kept at appropriate level, and the DSP system can detect an S-curve in the focusing error signal FE without errors to ensure a success of the layer change procedure. Thus, focus servo is stable during the SA collector 944 is moving. In one embodiment, the gain values (such as FEGain0, FEGain0′, FEGain 1, FEGain 1′) are determined in an off-line calibration process.

It is noted that during procedure of layer changes, the SA correction driver 912 continues moving the SA corrector 944 towards the position SA1 in some situations. In some other situations, the SA correction driver 912 moves the SA corrector 944 in several steps, such as two steps. It means that the SA correction driver 912 moves the SA corrector 944 to the position of layer jump temporally, such as the position SAJ shown on FIG. 10A, and then moves the SA corrector 944 to SA1.

Referring to FIG. 10B, a schematic diagram of another embodiment of gain adjustment of a focus error signal according to a position of the SA corrector 944 during a layer change is shown. Before a layer change procedure is performed, the position of the SA corrector 944 is at SA1, and a gain for generating the focusing error signal FE is FEGain1. When the SA correction driver 912 moves the SA corrector 944 from the position SA1 towards a position SA0, the micro processor 908 sends an adjusting signal A to the focus error signal generator 904, thus gradually adjusting the gain of the focus error signal FE from the value FEGain1 to the value FEGain1″. After the layer change occurs, the gain of the focus error signal FE is changed from FEGain1″ to FEGain0″. The SA correction driver 912 continues moving the SA corrector 944 towards the position SA0, and the micro processor 908 sends the adjusting signal A to the focus error signal generator 904 to gradually adjust the gain of the focus error signal FE from the value FEGain0″ to the value FEGain0. The amplitude of the focus error signal FE is therefore kept at appropriate level and the micro processor 908 can detect an S-curve in the focusing error signal FE without errors to ensure a success of the layer change procedure. In one embodiment, the gain values FEGain1, FEGain1″, FEgain0″, and FEGain0 are determined in an off-line calibration process.

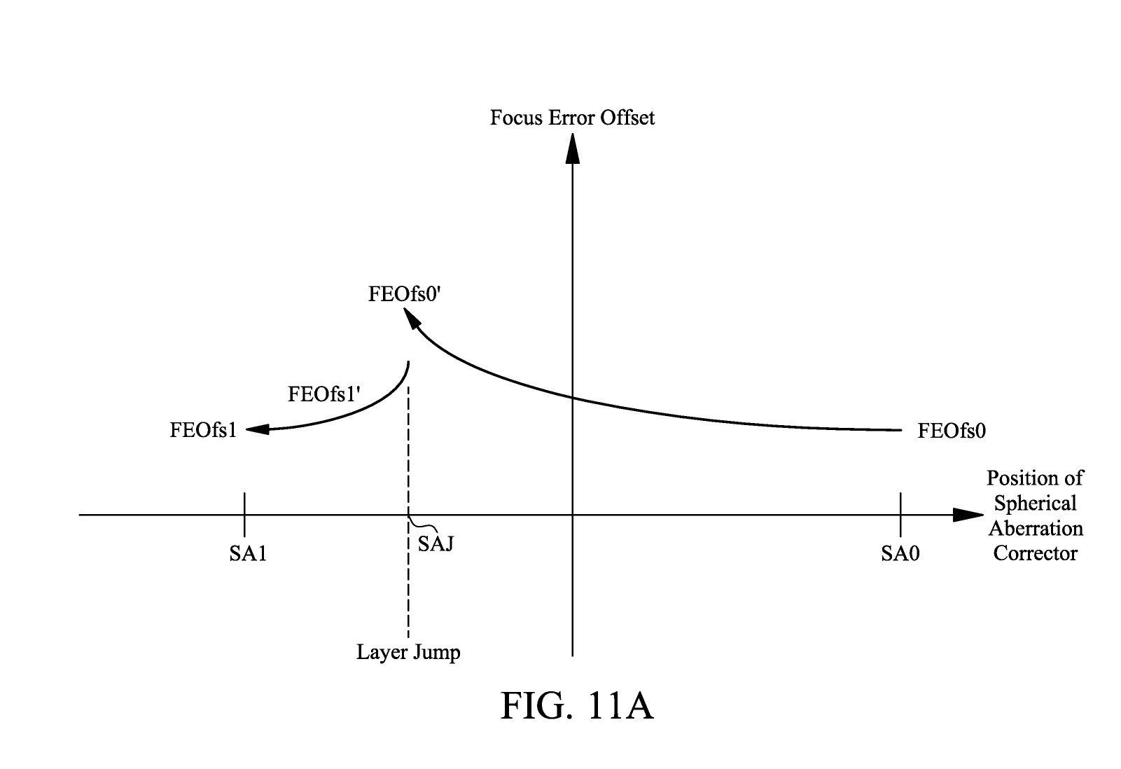

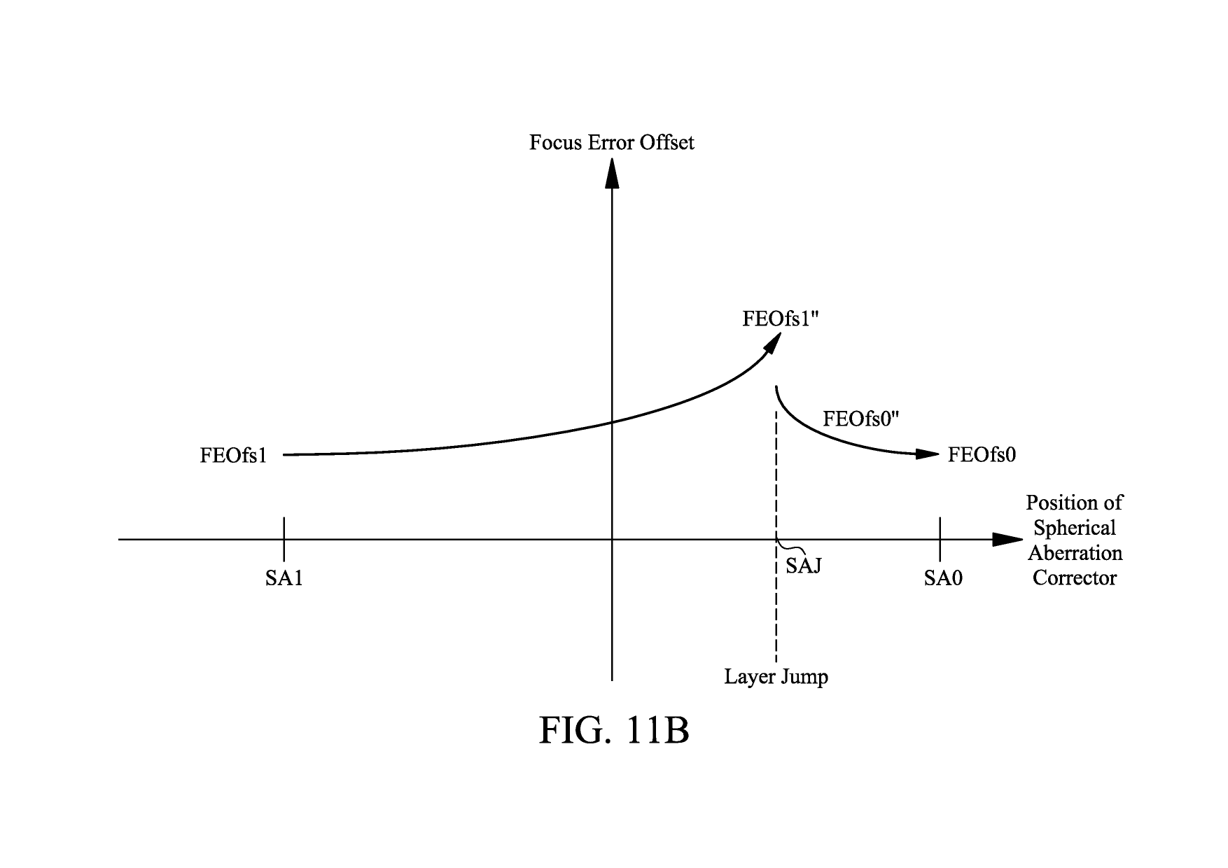

Referring to FIG. 11A, a schematic diagram of an embodiment of offset adjustment of a focus error signal according to a position of SA corrector 944 during a layer change is shown. Before a layer change procedure is performed, a spherical aberration position of the SA corrector 944 is at SA0, and an offset for generating the focusing error signal FE is FEOfs0. When the SA correction driver 912 moves the SA corrector 944 from the position SA0 towards a position SA1, the micro processor 908 sends an adjusting signal A to the focus error signal generator 904, thus stability of the focus servo is improved by gradually adjusting an offset of the focus error signal FE from the value FEOfs0 to the value FEOfs0′. After the layer change occurs, the offset of the focus error signal FE is changed from FEOfs0′ to FEOfs1′. The SA correction driver 912 moves the SA corrector 944 towards the position SA1, and the micro processor 908 sends the adjusting signal A to the focus error signal generator 904 to gradually adjust the offset of the focus error signal FE from the value FEOfs1′ to the value FEOfs1. The offset of the focus error signal FE is therefore kept at appropriate level and the micro processor 908 can detect an S-curve in the focusing error signal FE without errors to ensure a success of the layer change procedure. In one embodiment, the offset values FEOfs0, FEOfs0′, FEOfs1′, and FEOfs1 are determined in an off-line calibration process. Moreover, the offset of the focus error signal FE can be adjusted according to some specific functions in some embodiments, thus the adjustment of offset is controlled by the functions.

Referring to FIG. 11B, a schematic diagram of another embodiment of offset adjustment of a focus error signal according to a position of SA corrector 944 during a layer change is shown. Before a layer change procedure is performed, a position of the SA corrector 944 is at SA1, and an offset for generating the focusing error signal FE is FEOfs1. When the SA correction driver 912 moves the SA corrector 944 from the position SA1 towards a position SA0, the micro processor 908 sends an adjusting signal A to the focus error signal generator 904, thus gradually adjusting the offset of the focus error signal FE from the value FEOfs1 to the value FEOfs1″. After the layer change occurs, the offset of the focus error signal FE is changed from FEOfs1″ to FEOfs0″. The SA correction driver 912 continues moving the SA corrector 944 towards the position SA0, and the micro processor 908 sends the adjusting signal A to the focus error signal generator 904 to gradually adjust the offset of the focus error signal FE from the value FEOfs0″ to the value FEOfs0. The offset of the focus error signal FE is therefore kept at appropriate level and the micro processor 908 can detect an S-curve in the focusing error signal FE without errors to ensure a success of the layer change procedure. In one embodiment, the gain values FEOfs1, FEOfs1″, FEOfs0″, and FEOfs0 are determined in an off-line calibration process.

Similarly, when spherical aberration is corrected by changing an refractive index of an LCD device, the horizontal axes of FIGS. 10A, 10B, 11A, and 11B represent a refractive index value of the LCD device, and the micro processor 908 directs the focus error signal generator 904 to adjust the gain (amplitude) and/or offset level of the focus error signal FE according to the refractive index value of the LCD device, thus keeping an gain and/or offset of a focus error signal FE at appropriate level while spherical aberration is corrected.

Moreover, the procedure of SA correction driver 912 moves the SA corrector 944 in FIGS. 10A, 10B, 11A, and 11B includes continuing movement and movement with several steps, where is described in FIG. 10A already, and here is omitted for simplicity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for performing layer changes for an optical disk drive, wherein the optical disk drive intends to move a focus of a laserbeam from a present layer of an optical disk onto a target layer of the optical disk, and the method comprises:
determining an amplitude ratio between a first amplitude of a first S-curve of a previous focusing error signal and a second amplitude of a second S-curve of the previous focusing error signal, wherein the first S-curve and the second S-curve respectively correspond to the present layer and the target layer;
generating a focusing error signal while an object lens of the pickup head is moving towards a target position for focusing the laserbeam on the target layer;
amplifying or attenuating the focusing error signal according to the amplitude ratio to respectively obtain an amplified or attenuated focusing error signal;
determining whether the object lens has reached the target position according to the amplified or attenuated focusing error signal; and
halting moving of the object lens when the object lens is determined to have reached the target position.

2. The method as claimed in claim 1, wherein the determination of whether the object lens has reached the target position comprises:
detecting whether an S-curve occurs in the amplified or attenuated focusing error signal; and
determining that the object lens has reached the target position when an S-curve occurs in the amplified or attenuated focusing error signal.

3. The method as claimed in claim 1, wherein the determination of the amplitude ratio comprises:
moving the object lens focusing the laserbeam from the present layer towards the target position for focusing of the laserbeam on the target layer;
generating the previous focusing error signal while the object lens is moving;
detecting the first S-curve corresponding to the present layer and the second S-curve corresponding to the target layer from the previous focusing error signal;
measuring the first amplitude of the first S-curve and the second amplitude of the second S-curve; and
dividing the first amplitude by the second amplitude to obtain the amplitude ratio.

4. The method as claimed in claim 1, wherein the method further comprises:
performing a calibration process to determine a calibrated gain of the focusing error signal in advance; and
calibrating the focusing error signal according to the calibrated gain after the object lens has reached the target position.

5. The method as claimed in claim 1, wherein the optical disk is a Blu-ray Disc (BD).

6. An optical disk driving module, performing a layer change to move a focus of a laserbeam from a present layer of an optical disk onto a target layer of the optical disk, and the optical disk driving module comprises:
a focusing error generator, generating a focusing error signal according to a reflection signal from a pickup head while an object lens is moving; and
a digital signal processing system, determining an amplitude ratio between a first amplitude of a first S-curve of a previous focusing error signal and a second amplitude of a second S-curve of the previous focusing error signal, amplifying or attenuating the focusing error signal according to the amplitude ratio to respectively obtain an amplified or attenuated focusing error signal, determining whether the object lens has reached the target position according to the amplified or attenuated focusing error signal, and halt moving of the object lens when the object lens is determined to have reached the target position, wherein the first S-curve and the second S-curve respectively correspond to the present layer and the target layer.

7. The optical disk driving module as claimed in claim 6, wherein the digital signal processing system comprises:
a gain register, storing the amplitude ratio;
an amplification/attenuation module, amplifying or attenuating the focusing error signal according to the amplitude ratio to obtain an amplified or attenuated focusing error signal;
an S-curve detector, detecting whether an S-curve occurs in the amplified or attenuated focusing error signal, and determining that the object lens has reached the target position when the S-curve occurs in the amplified or attenuated focusing error signal; and
a focus control module, generating a focus servo output signal to the mechanical system to halt moving of the object lens when the object lens is determined to have reached the target position.

8. The optical disk driving module as claimed in claim 6, the focus error generator generates the previous focusing error signal while the object lens is moving, and the digital signal processing system detects the first S-curve corresponding to the present layer and the second S-curve corresponding to the target layer from the previous focusing error signal, measures the first amplitude of the first S-curve and the second amplitude of the second S-curve, and divides the first amplitude by the second amplitude to obtain the amplitude ratio.

9. The optical disk driving module as claimed in claim 8, wherein the digital signal processing system comprises:
an S-curve detector, detecting the first S-curve corresponding to the present layer and the second S-curve corresponding to the target layer from the previous focusing error signal;
an amplitude ratio determination module, measuring the first amplitude of the first S-curve and the second amplitude of the second S-curve, and dividing the first amplitude by the second amplitude to obtain the amplitude ratio; and
a gain register, storing the amplitude ratio.

10. The optical disk driving module as claimed in claim 6, wherein the optical disk drive performs a calibration process in advance to determine a calibrated gain of the focusing error signal, and the digital signal processing system restores the calibration gain to a gain register thereof to amplify or attenuate the focusing error signal according to the calibrated gain after the object lens has reached the target position.

11. The optical disk driving module as claimed in claim 6, wherein the optical disk is a Blu-ray disk (BD).

12. A method for controlling layer changes for an optical disk drive, wherein the optical disk drive intends to move a focus of a laserbeam from a present layer of an optical disk onto a target layer of the optical disk, and the method comprises:
generating a focusing error signal while the object lens is moving towards a target position for focusing the laserbeam on the target layer;
summing reflection signals generated by a pickup head to obtain a summation signal;
comparing amplitude of the summation signal with a threshold to determine whether the laserbeam is projected on a blank area or a data area of the target layer;
amplifying or attenuating the focusing error signal when the laserbeam is determined to be projected on the blank area;
determining whether the object lens has reached the target position according to the amplified or attenuated focusing error signal; and
halting moving of the object lens when the object lens is determined to have reached the target position.

13. The method as claimed in claim 12, wherein the step of amplifying or attenuating is executed according to types of the optical disk.

14. The method as claimed in claim 12, wherein the determination of whether the object lens has reached the target position comprises:
detecting whether an S-curve occurs in the amplified or attenuated focusing error signal; and
determining that the object lens has reached the target position when an S-curve occurs in the amplified or attenuated focusing error signal.

15. The method as claimed in claim 12, wherein determination of whether the laserbeam is projected on the blank area or the data area comprises:
determining that the laserbeam is projected on the blank area of the target layer when the amplitude of the summation signal is greater than the threshold; and
determining that the laserbeam is projected on the data area of the target layer when the amplitude of the summation signal is less than the threshold.

16. The method as claimed in claim 12, wherein the optical disk is a Blu-ray disk (BD).

17. An optical disk driving module, wherein the optical disk driving module intends to move a focus of a laserbeam emitted by a pickup head from a present layer of an optical disk onto a target layer of the optical disk, and the optical disk drive comprises:
a focusing error generator, generating a focusing error signal according to a reflection signal from the pickup head while a object lens of the pickup head is moving;
a summing circuit, generating a summation signal reflecting a strength of the reflection signal; and
a digital signal processing system, comparing an amplitude of the summation signal with a threshold to determine whether the laserbeam is projected on a blank area or a data area of the target layer, amplifying or attenuating the focusing error signal when the laserbeam is determined to be projected on the blank area, determining whether the object lens has reached the target position according to the amplified or attenuated focusing error signal, and halt moving of the object lens when the object lens is determined to have reached the target position.

18. The optical disk driving module as claimed in claim 17, wherein the digital signal processing system comprises:
a blank identification module, comparing the amplitude of the summation signal with the threshold to determine whether the laserbeam is projected on the blank area or the data area of the target layer;
an amplification/attenuation module, amplifying or attenuating the focusing error signal when the laserbeam is determined to be projected on the blank area;
an S-curve detector, detecting whether an S-curve occurs in the focusing error signal, and determining that the object lens has reached the target position when the S-curve occurs in the amplified or attenuated focusing error signal; and
a focus control module, generating a focus servo output signal to the mechanical system to halt moving of the object lens when the object lens is determined to have reached the target position.

19. The optical disk driving module as claimed in claim 17, wherein the pickup head detects the reflection with a plurality of photodetectors to generate a plurality of reflection signals, and the summing circuit sums the reflection signals to generate the summation signal.

20. The optical disk driving module as claimed in claim 17, wherein the digital signal processing module determines that the laserbeam is projected on the blank area of the target layer when the amplitude of the summation signal is greater than the threshold, and the digital signal processing module determines that the laserbeam is projected on the data area of the target layer when the amplitude of the summation signal is less than the threshold.

21. The optical disk driving module as claimed in claim 17, wherein the optical disk is a Blu-ray disk (BD).

22. An optical disk driving module, comprising:
a spherical aberration correction driver, driving a spherical aberration corrector according to a spherical aberration index when a layer change procedure is performed;
a focus error generator, deriving a focusing error signal from a reflection signal according to a gain and an offset, wherein the reflection signal is derived from an optical disk; and
a micro processor, generating an adjusting signal to direct the focus error generator to adjust the gain and/or the offset according to the spherical aberration index, thus keeping the focus error signal at appropriate level while spherical aberration is corrected.

23. The optical disk driving module as claimed in claim 22, wherein the spherical aberration index indicates a position of the spherical aberration corrector.

24. The optical disk driving module as claimed in claim 22, wherein the spherical aberration index indicates a reflective index of a LCD device.

25. The optical disk driving module as claimed in claim 22, wherein the micro processor detects an S-curve in the focus error signal, and determines whether to stop the focus coil from moving an object lens according to detection of the S-curve, thus completing the layer change procedure.

26. The optical disk driving module as claimed in claim 22, wherein the focus error signal generator amplifies or attenuates the focus error signal according to the gain and the offset.

27. The optical disk driving module as claimed in claim 22, wherein the gain and the offset are functions based on position of the spherical aberration corrector, the functions defines values of the gain and the offset according to positions of the spherical aberration corrector, and the micro processor determines the functions in an off-line calibration process.
